(19) United States
(12) Patent Application Publication
(10) Pub. No.: US 2008/0282182 A1
(43) Pub. Date: Nov. 13, 2008

(54) Control System For Networked Home Electrical Appliances

(75) Inventor: Naohisa Oosaka, Osaka (JP)

Correspondence Address: DLA PIPER US LLP, P. O. BOX 9271, RESTON, VA, 20195, US

(73) Assignees: KABUSHIKI KAISHA TOSHIBA, TOKYO (JP); TOSHIBA CONSUMER MARKETING CORPORATION, TOKYO (JP); TOSHIBA HA PRODUCTS CO., LTD, OSAKA (JP)

(21) Appl. No.: 11/569,844

(22) PCT Filed: May 27, 2005
(86) PCT No.: PCT/JP2005/009798

§ 371 Date: Nov. 30, 2006

(30) Foreign Application Priority Data
May 31, 2004 (JP) 2004-162216

(51) Int. Cl. G06F 3/048; G06F 17/00

(52) U.S. Cl. 715/772; 700/90

(57) ABSTRACT

A network household electric control system has a household electric appliance controlling ASP server installed as an external server (300) on the Internet. When household electric appliances (150) are to be controlled from an operation terminal (130) in the house of a customer through a home server (120), the GUI is transparently transmitted from an external server to the operation terminal and is displayed with the browser so that the household electric appliances are monitored and controlled through that GUI.

### TECHNICAL FIELD

The present invention relates to a control system for networked home electrical appliances.

### BACKGROUND TECHNOLOGY

In recent years, home electrical appliances with communication functions, or networked home electrical appliances and techniques for using them are energetically being developed. A customer who purchased a networked home electrical appliance arranges a home server serving as a gateway to establish a wired or wireless home network and connects the home network to a router, so that the appliance is connected through the router to the Internet. Then, the customer uses a portable terminal with a browsing function, such as a cellular phone, a PDA, or a portable personal computer, or an external computer and accesses the home server and networked home electrical appliance, to remotely monitor and control the appliance.

Household appliance manufacturers manufacture various kinds of networked home electrical appliances. Accordingly, a customer purchases a variety of products from different manufacturers, for example, a washing machine of a model oo from a company oo, a refrigerator of a model ΔΔ from a company ΔΔ, and an air conditioner of a model xx from a company xx. In this case, a home network to be established must have a home server that can undiscriminatingly connect to and communicate with the various networked home electrical appliances of various companies and remotely monitor and control them.

To include various functions characteristic to companies in networked home electrical appliances, manufacturers beforehand incorporate software for communication and remote control in communication units and micro-servers of the appliances. Although communication standardization is advancing for networked home electrical appliances, communicating with, monitoring, and controlling networked home electrical appliances that are connected to a home server and are different from one another depending on companies are achievable only by newly introducing software for communication, monitoring, and controlling whenever a networked home electrical appliance is newly added to the home server.

A networked home electrical appliance is a consumer appliance, and therefore, a customer who purchases a networked home electrical appliance from a store and arranges it in his or her house expects all functions including a communication function of the appliance to work as soon as it is plugged in. It is impossible to ask the customer who purchased the appliance for installing new software in the home server.

On the other hand, speed of technical innovation of household appliances is fast, and therefore, it is impractical to beforehand provide a home server with software that can wholly cover a variety of functions expected for household appliances.

In consideration of these factors, it is preferable to externally install an ASP (Application Service Provider) server having software for communicating with and remotely monitoring and controlling a variety of networked home electrical appliances, automatically access the ASP server from a home server when a networked home electrical appliance is newly connected to a home network, download software appropriate for the newly connected networked home electrical appliance according to minimum information about the appliance, and make the appliance usable.

### DISCLOSURE OF INVENTION

In view of the technical problems of the related art, an object of the present invention is to provide a control system for networked home electrical appliances that installs a home electrical appliance controlling ASP server as an external server in a global network such as the Internet, to allow an operation terminal in a customer's house to control a home electrical appliance through EL home server by making the external server behind the scenes transmit a GUI to the operation terminal, displaying the GUI with a browser, and enabling the GUI to be used to monitor and control the home electrical appliance.

An invention of claim 1 is a control system for networked home electrical appliances including an external server to receive through a global network a CGI program execution instruction from an optional terminal, execute a CGI program registered in advance, and transmit a result of the execution to the accessed terminal, a home electrical appliance having a communication function and connected to a home network, a home server connected to the home network, to control each home electrical appliance connected to the home network, and an operation terminal connected to the home network and having a browser function. The external server has a function of returning a screen or a control code corresponding to a request from the operation terminal. The home server has a function of receiving a request from the external server, a function of transmitting a request to the external server, a function of relaying a request from the operation terminal to the external server behind the scenes, a communication function of controlling each home electrical appliance, and a function of receiving a notification from each home electrical appliance.

An invention of claim 2 is characterized in that, in the control system for networked home electrical appliances of claim 1, the external server holds a GUI to monitor and control the home electrical appliance, and in response to an access from the operation terminal, the home server accesses the external server behind the scenes and displays the GUI on a screen of the operation terminal as if it is on its own device.

An invention of claim 3 is characterized in that, in the control system for networked home electrical appliances of claim 2, the GUI has a relative pass of a CGI program written in an action field of a command on the home server, and when receiving the command on the home server from the operation terminal, executes the CGI program specified by the relative pass in the action field of the command and returns a result of the execution to the operation terminal.

An invention of claim 4 is characterized in that, in the control system for networked home electrical appliances of claim 3, a module on the home server is executed according to the GUI supplied from the external server with use of arguments including a URL to be accessed upon a success of processing and a URL to be accessed upon an abnormal termination of processing.

An invention of claim 5 is characterized in that, in the control system for networked home electrical appliances of claims 1 to 4, a secured protocol is used for communication between the external server and the home server and an unsecured protocol is used for communication between the home server and the operation terminal.

An invention of claim 6 is characterized in that, in the control system for networked home electrical appliances of claims 1 to 5, full passes are described only for image files in the GUI output from the external server.

An invention of claim 7 is characterized in that, in the control system for networked home electrical appliances of claims 1 to 6, the external server provides different service menus when accessed through the home server and when directly accessed.

An invention of claim 8 is characterized in that, in the control system for networked home electrical appliances of claims 1 to 7, the operation terminal transmits data specifying its type and the external server refers to the data to determine the type of the operation terminal accessing the external server through the home server and provides a different service menu depending on the determined type.

An invention of claim 9 is characterized in that, in the control system for networked home electrical appliances of claims 1 to 8, the operation terminal or the home server holds customer identification information and transmits the customer identification information when accessing the external server and that the external server holds, as customer information, information about home electrical appliances of each customer, extracts corresponding customer information according to the customer identification information when providing a service menu in response to the access from the operation terminal or the home server, and enables only services providable by home electrical appliances owned by the customer in question.

According to the control system for networked home electrical appliances of the present invention mentioned above, an ASP server for controlling home electrical appliances is installed as an external server in a global network such as the Internet. When an operation terminal in the house of a customer is used to operate or control through a home server a home electrical appliance, the external server transmits a GUI to the operation terminal behind the scenes, so that the GUI is displayed in a browser and the home electrical appliance is operated or controlled through the GUI. The external server may hold control data and control programs for a variety of home electrical appliances. Then, without storing such data and programs in the home server, the operation terminal can be used to operate or control an optional home electrical appliance in the house through the home server. A variety of new products can be handled by newly registering control data and control programs for them to the external server. This can lighten load on the home server in operating and controlling a variety of home electrical appliances in the home.

### BRIEF DESCRIPTION OF DRAWINGS

FIG. 1 is a block diagram showing a control system for networked home electrical appliances according to an embodiment of the present invention.

FIG. 2 is a block diagram showing a functional structure of a home server according to the above-mentioned embodiment.

FIG. 3 is a block diagram showing a functional structure of a home electrical appliance according to the above-mentioned embodiment.

FIG. 4 is a block diagram showing a functional structure of an ASP server according to the above-mentioned embodiment.

FIG. 5 is a list showing logs of a home electrical appliance group according to the above-mentioned embodiment.

FIG. 6 is a sequence diagram 1 showing a process of remotely controlling a home electrical appliance from an operation terminal, according to the above-mentioned embodiment.

FIG. 7 is a sequence diagram 2 showing the process of remotely controlling a home electrical appliance from an operation terminal, according to the above-mentioned embodiment.

FIG. 8 is an explanatory view 1 showing flows of signals in the process of remotely controlling a home electrical appliance from an operation terminal, according to the above-mentioned embodiment.

FIG. 9 is an explanatory view 2 showing flows of signals in the process of remotely controlling a home electrical appliance from an operation terminal, according to the above-mentioned embodiment.

FIG. 10 is an explanatory view showing a central operation screen used to remotely control home electrical appliances from a home PC, according to the above-mentioned embodiment.

FIG. 11 is an explanatory view showing an individual operation screen used to remotely control a home electrical appliance from the home PC, according to the above-mentioned embodiment.

FIG. 12 is an explanatory view showing flows of signals when an operation terminal accesses an ASP server through a home server and when the operation terminal directly accesses the ASP server in a control system for networked home electrical appliances according to a second embodiment of the present invention.

### BEST MODE OF IMPLEMENTATION

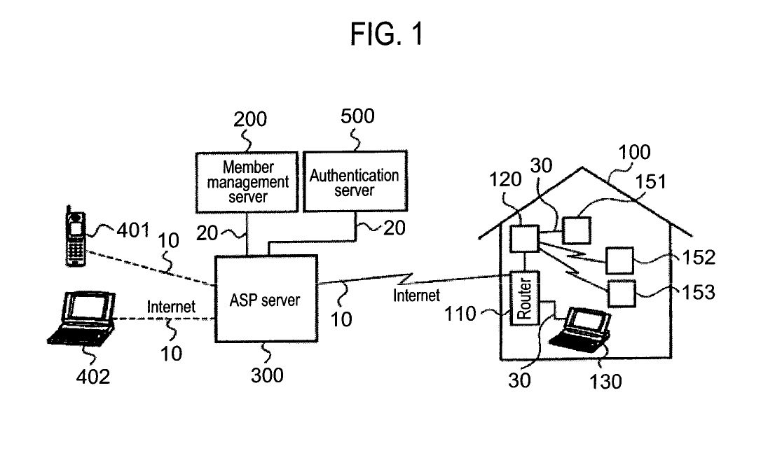

Embodiments of the present invention will be explained in detail with reference to the drawings. FIG. 1 shows a configuration of a control system for networked home electrical appliances according to an embodiment of the present invention. The control system for networked home electrical appliances of this embodiment includes a router 110, a home server 120, and various kinds of networked home electrical appliances 151 to 153 arranged in a customer's home 100, an ASP server (external server) 300 serving as a server for home electrical appliance information arranged in the Internet 10 that is a global network, a member management server 200 serving as a customer information management server, and an authentication server 500 to execute a member authentication service. The servers 200 and 500 are connected through a dedicated local network 20 to the ASP server 300. To the ASP server 300, a portable terminal 401 such as a cellular phone or a PDA and a PC 402 are externally connectable through the Internet 10. According to this embodiment, the local network is separated from the Internet to which unspecified people are connectable and is a network such as a private communication circuit or a VPN (Virtual Private Network) to which a person having no access right is not allowed to physically connect. The member management server 200 and authentication server 500 may be made of a single computer system to execute member information management and an authentication process with respective software.

In the customer's home 100, there are the router 110 to achieve connection to the Internet 10 and the home server 120 to manage a home network 30 serving as a sub-network. The home server 120 and networked home electrical appliances 151 to 153 are connected to the home network that is a wired and/or wireless sub-network. The home network 30 may be any one of or a plurality of a Bluetooth (registered trade name) network, a power-line network, an Ethernet (registered trade name), and a wifi wireless network.

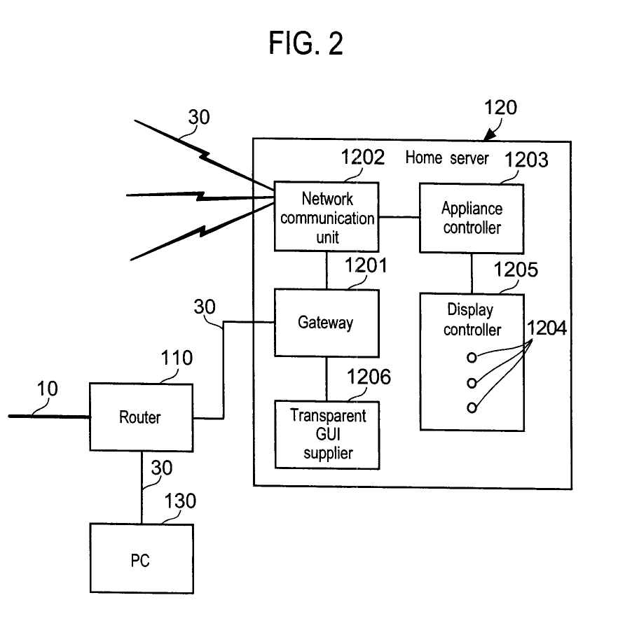

The home server 120 has a functional configuration shown in FIG. 2 and includes a gateway 1201, a network communication unit 1202 to conduct network communication with the home electrical appliances 151 to 153 connected to the home network 30, an appliance controller 1203 to accumulate monitor and control data for the various home electrical appliances, transmit an external command to each of the home electrical appliances, and transfer a response from each of the home electrical appliances, a display controller 1205 to emit light when any one of the home electrical appliances causes an event such as a fault or an abnormality with LEDs 1204 arranged on the server 120 in a specific manner corresponding to the kind of the event and restore a normal light emission state of the LEDs, and a hidden GUI supplier 1206 to provide a GUI behind the scenes when an operation terminal such as a computer, a digital television set, or a home terminal in the home accesses and controls through a browser any one of the home electrical appliances 151 to 153.

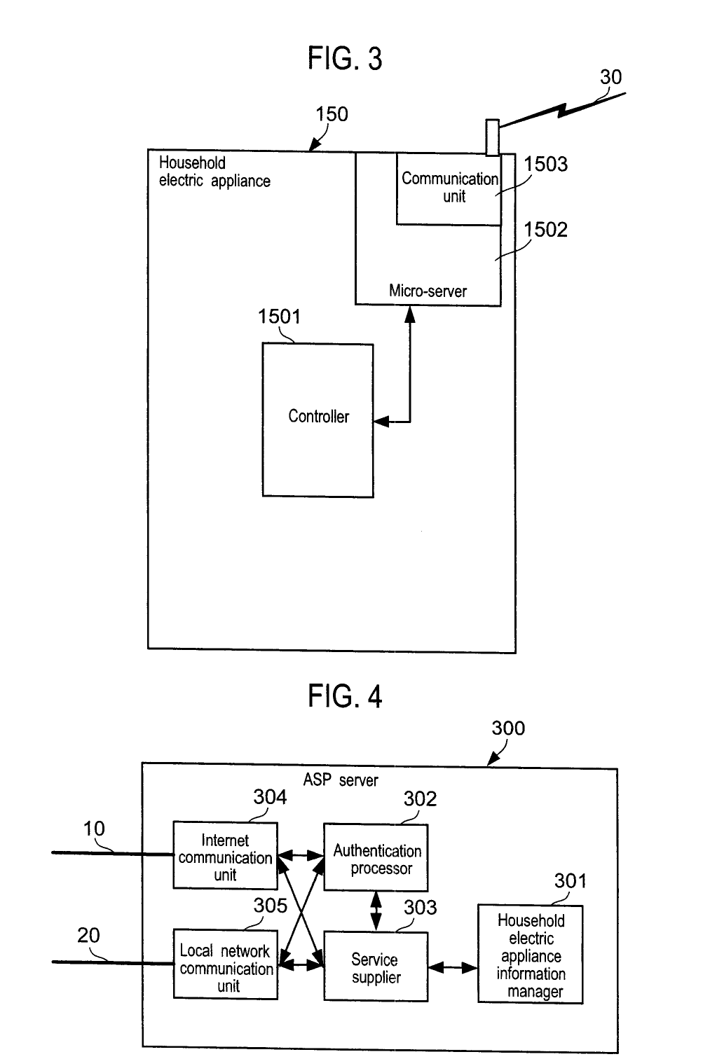

The networked home electrical appliances 151 to 153 may include a washing machine, a refrigerator, an air conditioner, an electronic oven, and the like (represented with a reference mark 150). As shown in FIG. 3, the home electrical appliance 150 has a controller 1501 to control operation of the home electrical appliance, a micro (μ)-server 1502 to record and store data about a manufacturer, a product name, a model number, and work/fault history, and a communication unit 1503 to communicate with the home server 120 through the home network 30.

As shown in FIG. 4, the ASP server 300 manages screen information, control information, and information about the monitored and controlled home electrical appliances that have diverse specifications depending on their manufacturers. The ASP server includes a home electrical appliance information manager 301 with a large-capacity storage unit, an authentication processor 302 to carry out a customer authentication process, a service supplier 303 to collect monitor and control information from home electrical appliances of each customer and supply a monitor/control screen serving as a GUI (graphical user interface), an internet communication unit 304, and a local network communication unit 305 to communicate with the member management server 200 through the private local network 20. The member management server 200 is arranged as hardware that is physically separated from the ASP server 300, to collect and manage customer information.

The member management server 200 is a server to collect and manage information on registered members who receive services from this system. This server accumulates personal information about members, information about the product names and model numbers of home electrical appliances related to the home server 120 of each member, and data such as member identification numbers and passwords required for a log-in procedure.

The authentication server 500 carries out an authentication process for a person accessed to the ASP server 300. Namely, it compares the member identification number and password of the person with data in the member management server 200 and determines whether or not the person can log in.

Operation of the control system for networked home electrical appliances of the above-mentioned configuration will be explained.

[Member Registration]

A person who uses the control system for networked home electrical appliances according to the embodiment must register as a member. The member registration is carried out by accessing through the router 110 the ASP server 300 from the operation terminal 130 having a browser function, such as a dedicated home terminal, a home PC, or a digital television set, by downloading a member registration screen, by entering through the screen the personal information, identification number, password, and the like of the person, and by transmitting the entered data. The personal information, identification number, password, and the like of the person are registered from the ASP server 300 to the member management server 200. In this member registration procedure, the ASP server 300 receives and registers unique identification information of the router 110 and home server 120 and identification information such as MAC addresses of the networked home electrical appliances 151, 152, and 153 that are connected through the home network 30 to the home server 120.

[Registration of New Home Electrical Appliance]

When a newly purchased home electrical appliance is connected to the home network 30, the home server 120 detects the same, receives information about the newly added home electrical appliance, automatically logs in the ASP server 300 with its own unique ID, and transfers the information such as the manufacturer name, product name, type, and ID of the newly added home electrical appliance. The ASP server 300 receives the information about the new appliance, relates the same to the ID of the home server 120, and registers it as home electrical appliance information. After the completion of registration, a completion notification is returned to the home server 120, which updates information about connected appliances.

[Work History Accumulation]

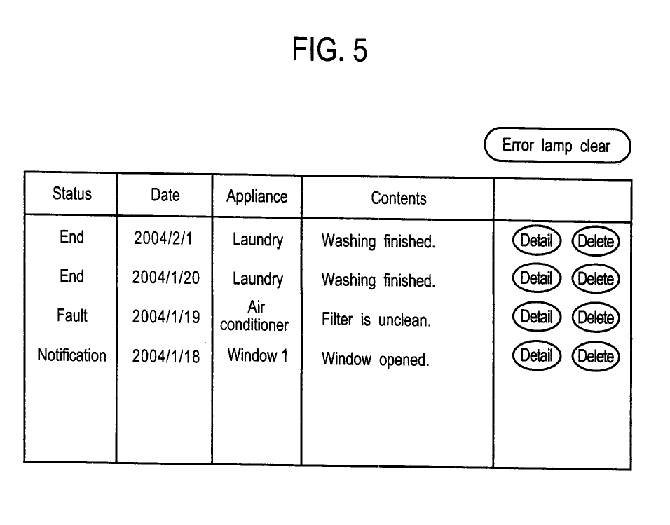

The ASP server 300 accumulates, for each home server, work history of the home electrical appliances 151, 153, and 155 connected to the home server 120. If any one of the home electrical appliances causes an event such as a power-on, power-off, washing completion, or filter contamination alarm event, the home electrical appliance in question transmits an event occurrence notification to the home server 120. In response to the event occurrence notification, the home server 120 accesses and automatically logs in the ASP server 300 beforehand specified as a link destination and transfers the event information from the home electrical appliance to the ASP server. The ASP server 300 relates the received event information to the ID of the home server 120 and registers the same as a log of the home electrical appliance. Instead of the home server 120 of each member, the ASP server 300 accumulates and manages logs of the networked home electrical appliances as shown in FIG. 5, to relieve the home server 120 from excessive load. As a result, the home server 120 is not required to have high-function, high-performance specifications, and therefore, the home server 120 can reduce the cost thereof.

[Access from Operation Terminal]

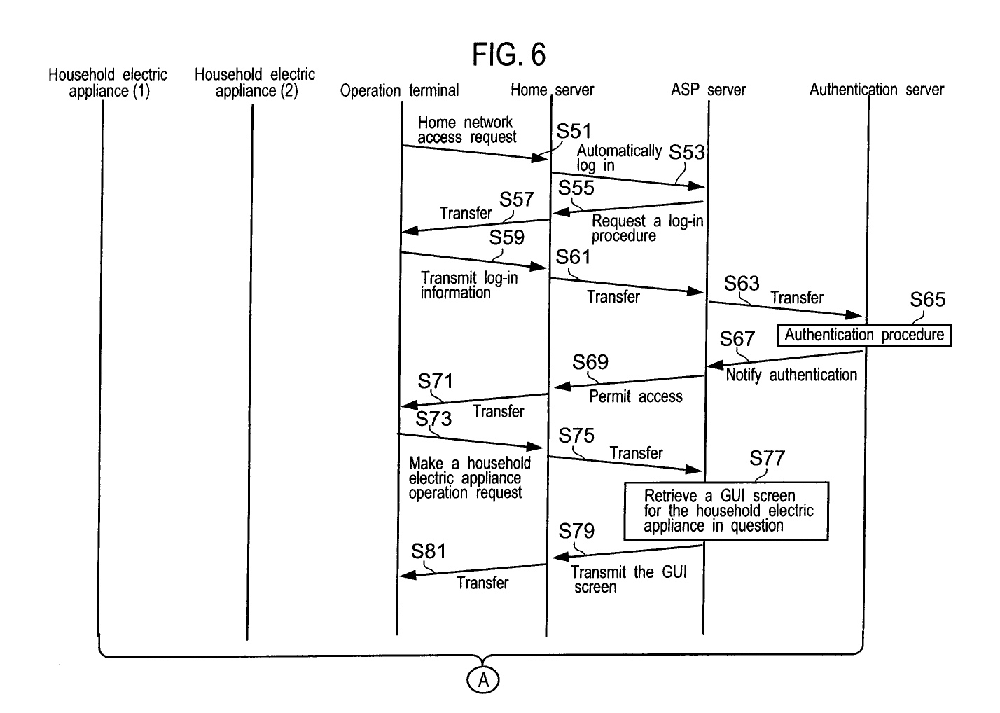

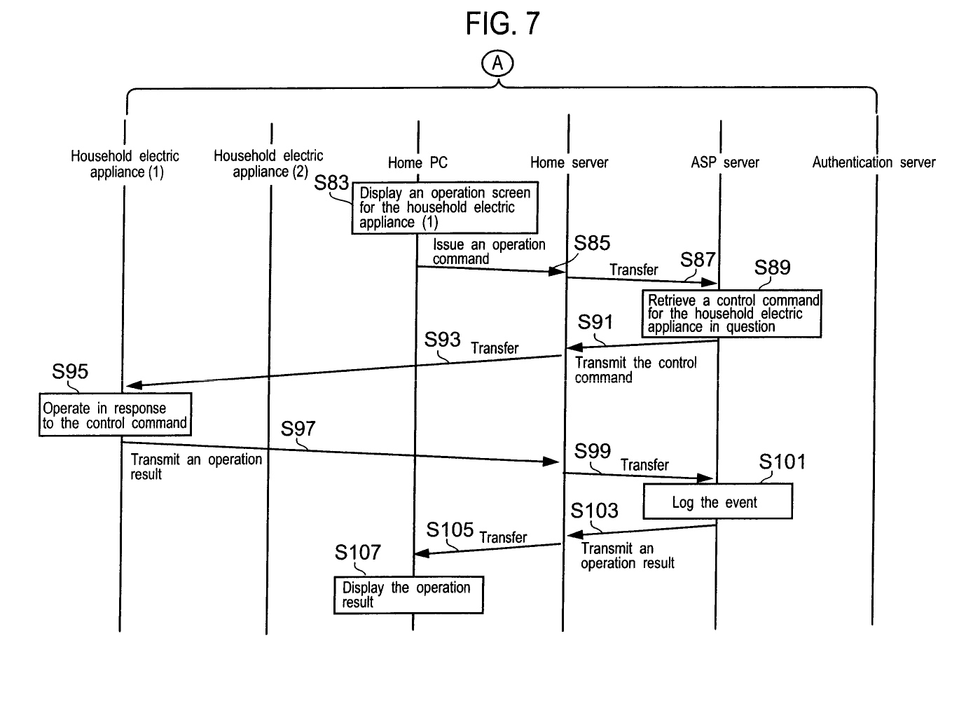

The member can use the operation terminal 130 such as a dedicated terminal, a home PC, or a digital television set to run a browser and operate the home electrical appliances 151 to 153 with the browser. As shown in FIGS. 6 and 7, the member connects the operation terminal 130 to the router 110, starts a browser, and accesses the home server 120 with a browser screen (step S51). In response to this, the home server 120 accesses through the Internet 10 the ASP server 300 that is linked in advance (step S53). The ASP server 300 requests a log-in procedure (steps S55 and S57), and the member enters an ID and a password with the operation terminal 130 to achieve the log-in procedure (step S59). The home server 120 transfers the log-in information to the ASP server 300 (step S61). The ASP server 300 communicates with the authentication server 500 through the local network 20 and executes an authentication procedure (steps S63 and S65). If the authentication procedure is successful, the ASP server 300 transmits an access permission for the operation terminal 130 and provides a GUI screen to allow the operation terminal 130 to access an optional home electrical appliance connected to the home network 30 (steps S67 to S71).

Then, the member transmits from the operation terminal 130 an operation request by specifying a home electrical appliance (step S73). The operation request is transmitted through the home server 120 to the linked ASP server 300 (step S75). The ASP server 300 retrieves a registered GUI service screen for the home electrical appliance (in this example, the home electrical appliance (1)) and transmits the retrieved service screen to the operation terminal 130, so that the operation screen of the home electrical appliance is displayed in the browser screen (steps S77 to S83).

In the GUI service screen displayed on the operation terminal 130, the member carries out, for example, a power-on, power-off, or temperature setting operation (step S85). The operation command is transferred from the home server 120 to the ASP server 300 in the Internet (step S87). From there, a corresponding operation signal is issued (steps S89 and S91) and is transferred through the home server 120 to the corresponding home electrical appliance (2) (step S93), to execute the operation (step S95). An operation result is returned from the home electrical appliance (1) to the home server 120 (step S97), which transfers the same to the ASP server 300 (step S99). The ASP server 300 retrieves a corresponding control result screen and returns the same through the home server 120 to the operation terminal 130 (steps S103 and S105). Receiving the control result screen information, the operation terminal 130 displays the same to allow the member to confirm the operation result (step S107).

In this way, operation events of the home electrical appliances can centrally be collected, logged, and managed member by member by the ASP server 300, to reduce load from the home server 120.

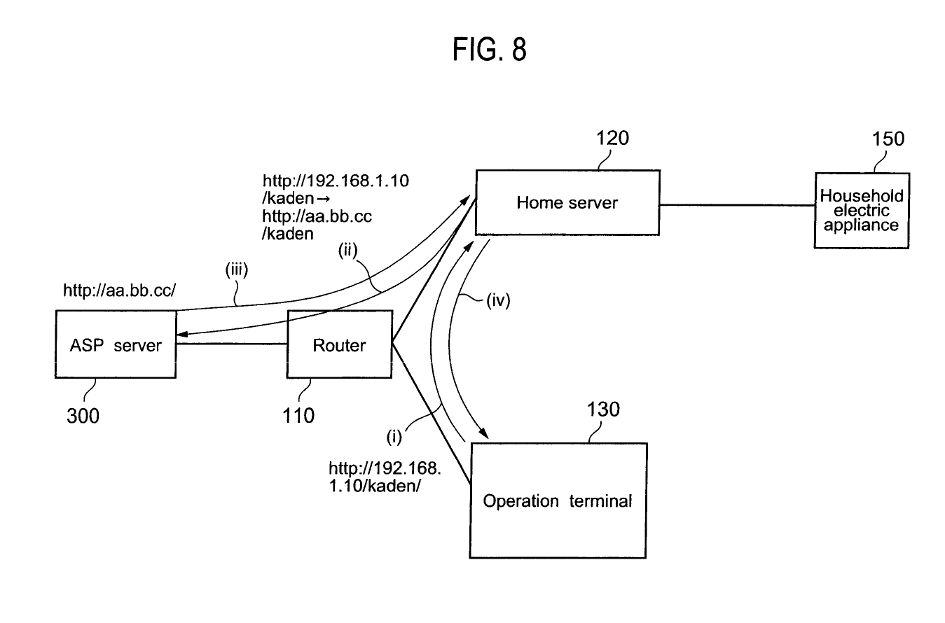

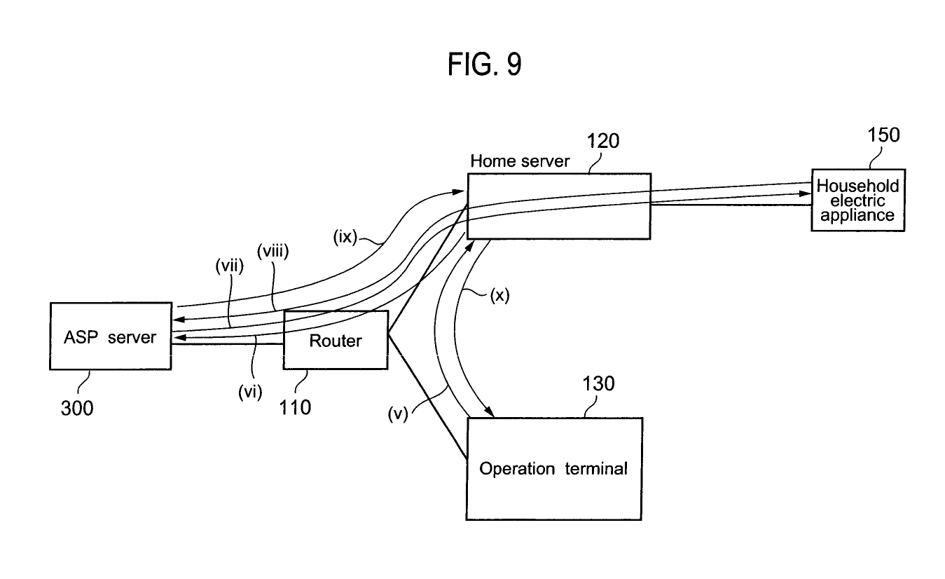

The above-mentioned procedures will be explained with reference to examples shown in FIGS. 8 and 9.

(i) When the operation terminal 130 in the house 100 accesses and operates a certain home electrical appliance 150, a browser is started and http://192.168.1.10/kaden/ is entered in the browser, to request the home server 120 for a list of home electrical appliances.

(ii) When the request is made to http://192.168.1.10/kaden/ of its own, the home server 120 automatically refers to http://aa.bb cc/kaden/ in the external ASP server 300.

(iii), (iv) The home server 120 receives a result from the ASP server 300 and transfers the same to the operation terminal 130, which displays a home electrical appliance list in the browser screen.

This operation is realized with the home server 120 being set as follows by using a web software “apache”:

[Mathematical 1]

ProxyPass /kaden/“https://aa.bb.cc/”
ProxyPassReverse /kaden/“https://aa.bb.cc/”

Within the home network, an unsecured protocol of http is used, and for the global network connecting the home server 120 to the external server 300, a secured protocol of https is used.

(v), (vi) From the home electrical appliance list, a home electrical appliance 150 to operate is selected and an operation request is transmitted. For this, the operation terminal 130 transmits a CGI execution request to the home server 120. In this case, a pass is http://192.169.1.10/cgi-bin/abc.cgi. An html output to execute this is as follows:

[Mathematical 2]

<html>
...
<form action= /cgi-bin/abc.cgi
...
</html>

This output is actually carried out by the ASP server 300. At this time, a relative pass from /cgi-bin/ can be used without knowing the IP address of the home server 120.

(vii), (viii) The ASP server 300 executes a corresponding CGI to control the electric appliance 150 in question through the home server 120, and obtains a control result.

(ix), (x) The ASP server 300 transmits the control result to the request source, i.e., the operation terminal 130 through the home server 120.

The execution result of the CGI script is used to determine a jump destination URL, and an html page of the jump destination is displayed in the browser of the operation terminal 130. With this technique, the home server 120 is not required to hold the GUI, and therefore, load on the home server is reduced. An example of the html is as follows:

[Mathematical 3]

<html>
...
<form action= /cgi-bin/abc.cgi ...>
<input type=hidden nake=link

value=‘http://aa.bb.cc/success.html’>

<input type=hidden nake=linkerr

value=‘http://aa.bb.cc/error.html’>

</form>
...
</html>

When using the secured protocol of https for the external network, this embodiment employs http-based absolute passes for images and other information that need no encryption, as shown in Mathematical 4. This reduces load on the ASP server 300 and home server 120 and improves processing speed.

[Mathematical 4]

<html>
...
<img src=“http://aa.bb.cc/img/1.gif”>
<form action= /cgi-bin/abc.cgi ...>
<input type=hidden nake=link

value=‘http://aa.bb.cc/success.html’>

<input type=hidden nake=linkerr

value=‘http://aa.bb.cc/error.html’>

</form>
...
</html>

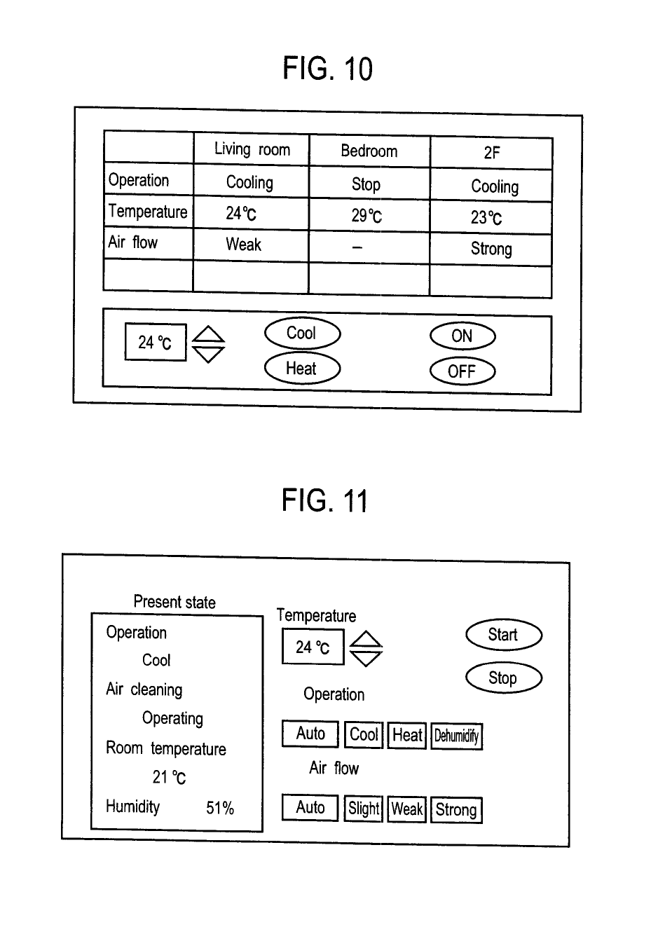

FIG. 10 shows an example of a remote-control screen for air conditioners. All air conditioners connected to the home network 30 in the house 100, i.e., an air conditioner in a living room, that in a bedroom, and that on the second floor are listed to show operation states thereof. In addition, operational parts for central operation are arranged. Each operational part may be the greatest common divisor of the air conditioners. For example, there are a list box of set temperatures, a “Cooling” mode button, a “Heating” mode button, a power ON button, and a power OFF button. In addition to the air-conditioner central control window, an individual control window for each of the air conditioners is linked as a lower level of the list. If, for example, the air conditioner on the second floor is selected, an individual control window for the second-floor air conditioner is developed as shown in FIG. 11. The window of FIG. 11 displays “Present states” and individual operational parts including a list box of “Set temperatures,” operation mode select buttons of “Auto,” “Cooling,” “Heating,” and “Dehumidification,” air-flow selection buttons of “Auto,” “Slight,” “Weak,” and “Strong,” and power ON and OFF buttons. In this way, the central control and individual control are realized. From the central control screen of FIG. 10, it is possible to list and grasp the state of each home electrical appliance arranged in the house. Also, it is possible to operate various functions of new and existing products and products of different grades.

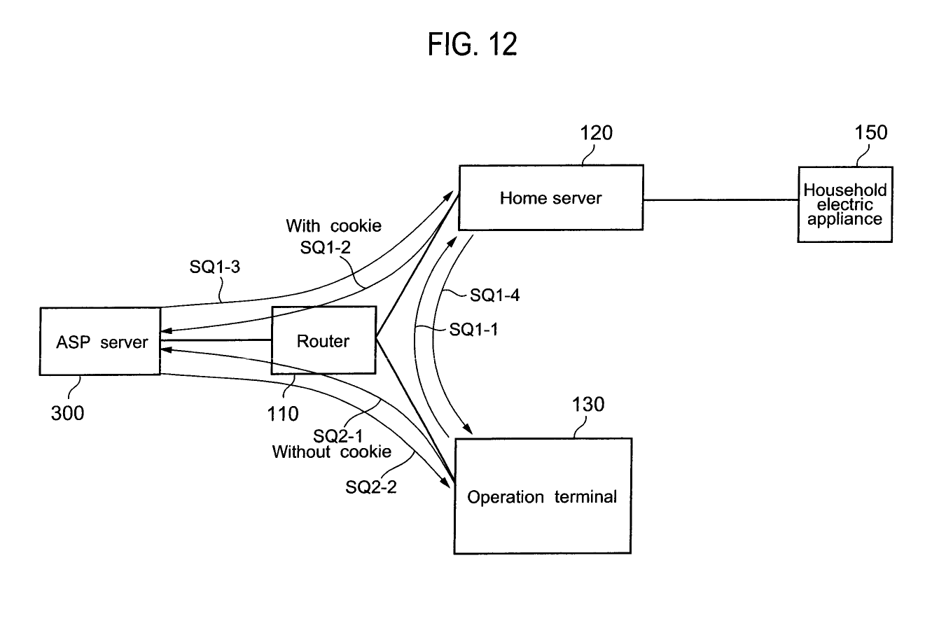

In the control system for networked home electrical appliances according to the embodiment, an access from the operation terminal 130 to the ASP server 300 through the home server 120 may be distinguished from a direct access between them. In this case, a sequence diagram of FIG. 12 is used. An access through the home server 120 to the ASP server 300 is made by adding a predetermined cookie to a transmission from the home server 120 to the ASP server 300. The ASP server 300 identifies the cookie and makes information downloadable so that the operation terminal 130 may conduct various control operations as required (SQ1-1 to SQ1-4). For a direct access from the operation terminal 130 by bypassing the home server 120, the ASP server 300 identifies that no cookie is added and supplies only limited information to the operation terminal 130 (SQ2-1 and SQ2-2).

It is sometimes necessary to identify whether the operation terminal 130 according to the above-mentioned embodiment is a home PC, a digital television set, or a home terminal incorporating various operation functions specific to a networked home electrical appliance and provide a different service depending on the identified result. If the operation terminal 130 is a home terminal and if the home terminal accesses the ASP server 300 through the home server 120, the ASP server 300 identifies the home terminal and provides a GUI specific to the home terminal, to establish an environment that allows for multifunctional remote monitoring and controlling operations.

The above-mentioned embodiments have explained functions of the system. The present invention realizes these functions by installing software in computer systems at various locations and by executing the software. Processing methods achieved by the software in the computer systems and the software itself are included in the technical scope of the present invention. An ASP server that realizes the above-mentioned functions is also included in the technical scope of the present invention.

### INDUSTRIAL APPLICABILITY

According to the control system for networked home electrical appliances of the present invention, any one of networked home electrical appliances connected to a home network may trigger an event. In response to the event, a home server accesses an external ASP server beforehand specified as a linked destination, automatically logs in the ASP server, and transfers event information from the networked home electrical appliance to the ASP server. The ASP server receives the event information, relates the same to a home server ID, and registers a log of the networked home electrical appliance in question. The ASP server accumulates and manages, instead of the home server of each member, logs of networked home electrical appliances, thereby removing excessive load from each home server. Namely, each home server is not requested to have high-function, high-performance specifications. This results in lowering the cost of the home server and minimizing the expenses of a user of networked home electrical appliances.

1. A control system for networked home electrical appliances comprising:
an external server to receive through a global network a CGI program execution instruction from an optional terminal, execute a CGI program registered in advance, and transmit a result of the execution to the accessed terminal;
a home electrical appliance having a communication function and connected to a home network;
a home server connected to the home network, to control each home electrical appliance connected to the home network; and
an operation terminal connected to the home network and having a browser function, and
the external server is configured to have a function of returning a screen or a control code corresponding to a request from the operation terminal, and
the home server is configured to have a function of receiving a request from the external server, a function of transmitting a request to the external server, a function of relaying a request from the operation terminal to the external server behind the scenes, a communication function of controlling each home electrical appliance, and a function of receiving a notification from each home electrical appliance.

2. The control system for networked home electrical appliances as set forth in claim1, characterized in that:
the external server holds a GUI to monitor and control the home electrical appliance; and
in response to an access from the operation terminal, the home server accesses the external server behind the scenes and displays the GUI on a screen of the operation terminal as if it is on its own device.

3. The control system for networked home electrical appliances as set forth in claim 2, characterized in that:
the GUI has a relative pass of a CGI program written in an action field of a command on the home server; and
when receiving the command on the home server from the operation terminal, the GUI executes the CGI program specified by the relative pass in the action field of the command and returns a result of the execution to the operation terminal.

4. The control system for networked home electrical appliances as set forth in claim 3, characterized in that a module on the home server is executed according to the GUI supplied from the external server with use of arguments including a URL to be accessed upon a success of processing and a URL to be accessed upon an abnormal termination of processing.

5. The control system for networked home electrical appliances as set forth in any one of claims 1 to 4, characterized in that a secured protocol is used for communication between the external server and the home server and an unsecured protocol is used for communication between the home server and the operation terminal.

6. The control system for networked home electrical appliances as set forth in any one of claims 1 to 5, characterized in that full passes are described only for image files in the GUI output from the external server.

7. The control system for networked home electrical appliances as set forth in any one of claims 1 to 6, characterized in that the external server provides different service menus when accessed through the home server and when directly accessed.

8. The control system for networked home electrical appliances as set forth in any one of claims 1 to 7, characterized in that:
the operation terminal transmits data specifying its type; and
the external server refers to the data to determine the type of the operation terminal accessing the external server through the home server and provides a different service menu depending on the determined type.

9. The control system for networked home electrical appliances as set forth in any one of claims 1 to 8, characterized in that:
the operation terminal or the home server holds customer identification information and transmits the customer identification information when accessing the external server; and
the external server holds, as customer information, information about home electrical appliances of each customer, extracts corresponding customer information according to the customer identification information when providing a service menu in response to the access from the operation terminal or the home server, and enables only services providable by home electrical appliances owned by the customer in question.
